(19) United States
(12) Patent Application Publication
(10) Pub. No.: US 2013/0193133 A1
(43) Pub. Date: Aug. 1, 2013

(54) POWER SUPPLY DEVICE FOR A CRUCIBLE HEATER AND METHOD FOR ITS OPERATION

(71) Applicants: Uwe Baumbach, Zwickau (DE); Mike Rudolph, Chemnitz (DE)

(72) Inventors: Uwe Baumbach, Zwickau (DE); Mike Rudolph, Chemnitz (DE)

(73) Assignee: Siemens Aktiengesellschaft, Munchen (DE)

(21) Appl. No.: 13/563,119

(22) Filed: Jul. 31, 2012

(30) Foreign Application Priority Data
Aug. 1, 2011 (EP) 11176125.0

(51) Int. Cl. H05B 1/02; H05B 3/02

(52) U.S. Cl. CPC H05B 1/02; H05B 3/02; H05B 1/0202
USPC 219/488; 219/541; 219/508; 219/490

(57) ABSTRACT

A power supply device for a crucible heater includes a heating circuit having an input terminal, and at least two power supply modules having each an output terminal. The output terminals of at least two power supply modules are connected in parallel to the input terminal of the heating circuit. A process control device controls the at least two power supply modules. Optionally, a heating control device can be provided instead of the process control device for controlling the power supply modules.

### CROSS-REFERENCES TO RELATED APPLICATIONS

This application claims the priority of European Patent Application, Serial No. 11176125.0, filed Aug. 1, 2011, pursuant to 35 U.S.C. 119(a)-(d), the content of which is incorporated herein by reference in its entirety as if fully set forth herein.

### BACKGROUND OF THE INVENTION

The present invention relates to a power supply device for a crucible heater. The invention also relates to a method for operating the power supply device.

The following discussion of related art is provided to assist the reader in understanding the advantages of the invention, and is not to be construed as an admission that this related art is prior art to this invention.

To melt the weight of the sample in crucible heaters, in particular in crystal growing systems, e.g. using the Czochralski method, low-resistance graphite heaters are normally used. In known power supply devices the heating output needed for this is provided by actuators (thyristor controllers), which work on the generalized phase control principle. These power supply devices have a mains input terminal and one or more direct voltage output terminals. Operation of these known power supply devices has for the most part revealed the disadvantages listed below.

The harmonic waves (harmonics) generated by the power supply device result in increased system losses. Industrial customers are therefore encouraged by their energy supplier to take suitable measures to reduce the system perturbation they cause. Because reactive power consumed in the event of the minimum value defined by the energy supplier for the power factor being undershot is billed separately, reactive power losses must be limited using separate technical measures. Passive or active filter circuits are used for this, for example. Alternatively, a power supply is also known in which thanks to the interworking of a linear coarse actuator (variable transformer) and a fast fine actuator the disturbances on the input side caused by the power supply are significantly reduced. To improve the power factor of the power supply use is made of compensation systems.

Conventional power supply devices for crucible heater largely work in the partial-load range. Power supplies that work on the generalized phase control principle, e.g. thyristor controllers, typically exhibit relatively low efficiency in the partial-load range, which is generally accepted.

The superimposed alternating current, also called ripple current, generated by known power supply systems on the secondary side can negatively impact on the temperature control process of a crucible heater, since a reduced signal-to-noise ratio occurs at the sensor input terminals of the temperature controller. Furthermore, this ripple current results in undesired side-effects at the graphite heater. For example, mechanical vibrations of the graphite heater can occur. In addition, the electromagnetic alternating fields generated by the ripple current can create unpredictable magnetic fields in the crucible and this negatively impacts on the crystal-growing process, since it is conversely the case that specifically generated and superimposed magnetic fields have a positive effect. Interference voltages on the output side are damped by active and passive filters.

System incidents that sometimes occur in the supply network of the energy supply company or also in the in-house network, e.g. flickers, peaks or voltage dips, result in secondary-side emitted interference in known power supply systems, in consequence of the generalized phase control principle or also wave-packet control, and thus in a reduced signal-to-noise ratio at the sensor input terminals of the temperature controller. This in turn can result in quality disruptions in the process, i.e. the control of the heating output, through to process loss. If incidents occur in the power supply, the process may be aborted. Active and passive line filters are generally used to counter the effects of brief system incidents on a crystal-growing process. Failures of system-related components of the power supply generally result in the process being aborted.

It would therefore be desirable and advantageous to obviate prior art shortcomings and to provide an improved device and method for preventing or reducing the aforementioned disadvantages of known power supply devices, in particular reducing the feedback to the power grid generated during operation, reducing the ripple current on the output side and increasing the efficiency.

It would also be desirable and advantageous to increase the availability of the power supply and thus the stability of the crystal-growth process.

### SUMMARY OF THE INVENTION

According to one aspect of the present invention, a power supply device for a crucible heater includes at least one heating circuit having an input terminal, at least two power supply modules having each an output terminal, with the output terminals of at least two power supply modules being connected in parallel to the input terminal of the at least one heating circuit and a process control device for controlling the at least two power supply modules.

According to another aspect of the present invention, a method for operating a power supply device for a crucible heater having at least one heating circuit with at least two power supply modules and a process control device for controlling the at least two power supply modules includes the steps of connecting output terminals of the at least two power supply modules in parallel and connecting the parallel connection to a corresponding heating circuit, and activating or deactivating the at least two power supply modules separately for each heating circuit as a function of a process flow or when a malfunction occurs in individual power supply modules.

The invention is here based on the knowledge that high outputs, e.g. in the range between 200 and 500 kW, are required for operating crucible heaters, in particular in crystal growing systems, with currents of several thousand amperes flowing. The output must be precisely structured here and at the same time safety aspects must be borne in mind because of the high currents. This knowledge is implemented such that similar power supply modules are connected together in a switchgear cabinet.

The advantage of the invention is that feedback into the power grid is reduced. Thus separate measures for line filtering are generally not necessary. Depending on the current load requirement individual power supply modules can be switched on or of to operate the active power supply modules at as optimal an operating point as possible and thus to achieve an improved power factor. The efficiency can as a result be improved in particular in the partial-load range. Thus separate measures, such as operating the power supply on reactive-power compensation equipment, are not necessary. Costs can also be saved in this way. Primary-side system incidents, such as flickers, peaks or voltage dips, are much less noticeable on the output side with the inventive power supply device than with known power supply devices. The transmission of temporary electromagnetic disturbance fields in the direction of the crucible heater is thus prevented, resulting in increased process stability, in particular of a crystal growing process.

According to an advantageous feature of the present invention, a heating control device may be connected between the process control device and the power supply modules for controlling and monitoring the power supply modules. The heating control device may be managed by the process control device, which receives status and error messages from different process monitoring components, e.g. temperature monitoring, cooling water monitoring, pressure monitoring.

Asymmetrical network loads can be prevented by connecting the input side of the power supply device of each power supply module to a three-phase power grid.

According to an advantageous feature of the present invention, each power supply module may include three identical submodules, which may be connected together via an internal system bus. Each submodule may optionally comprise a rectifier unit.

According to another advantageous feature of the present invention, each submodule may include a power factor correction stage. The power factor correction stage, also called a PFC stage, permits a significant reduction in system perturbations compared to known power supply devices for crucible heaters.

Clocked output stages may optionally be connected downstream of the power factor correction stage. As a result the quality of the output voltage compared to known power supply devices can be significantly improved, since the ripple current is reduced. With a reduced ripple current only small inductively generated lateral forces occur in the heating circuit, e.g. at a graphite heater. As a result mechanical vibrations of the graphite heater are reduced and its service life is thus extended.

According to an advantageous feature of the present invention, each power supply module may include a communication interface for exchanging status and control information with the process control device or heating control device. Status and error messages may then be displayed e.g. using an LED (Light Emitting Diode) display which may be, for example, arranged directly at a front of the power supply module or submodule, via an HMI (Human-Machine-Interface) at a switchgear cabinet in which the power supply device is arranged, and via the communication interface.

According to an advantageous feature of the present invention, in the event of a malfunction of one of the power supply modules, a signal may be transmitted via a communication interface from the defective power supply module to a heating control device connected between the process control device and the power supply modules and the heating control device deactivates the defective power supply module. To this end, the heating control device may send a corresponding signal to deactivate the defective power supply module.

Alternatively, in the event of a fault in one of the power supply modules, a signal may be transmitted via a communication interface from the defective power supply module to the process control device and the process control device then deactivates the defective power supply module. To this end, a corresponding control signal is sent from the process control device to the power supply module. This prevents defective power supply modules from negatively affecting the output voltage or causing system perturbations in further operation.

According to another advantageous feature of the present invention, the output of the deactivated power supply module may additionally be assigned at least proportionately to the one or more power supply modules that are still active in the associated heating circuit, if the output required in the associated heating circuit is less than or equal to a maximum output of the active power supply modules, i.e. a total of the maximum output of the power supply modules still available in the corresponding heating circuit. This permits a higher availability of the power supply device. If a power supply module fails, then the recovery time of the power supply is significantly shorter than that of, for example, conventional power supply devices. Thus the crucible growth system can be returned to operation significantly faster.

According to an advantageous feature of the present invention, a power supply module that is not required may be deactivated, and the power supply module not required may automatically be activated again if a power supply module connected in parallel fails or is disrupted. As a result, it is possible to optimize the operating point of the power supply device, in particular in the partial-load range.

Alternatively, a power supply module that is not required may be deactivated, and the power supply module not required may be manually or automatically activated—optionally using a confirmation acknowledgement—if a power supply module connected in parallel fails or is disrupted.

Possible operating modes for the deactivated power supply modules are both “Hot Standby Mode” (AC input terminal active) or “Cold Standby Mode” (AC input terminal deactivated). The operating modes can be used for a power supply module as required; for example, even if several power supply modules are deactivated, some of the deactivated power supply modules can be operated in “Hot Standby Mode” and some in “Cold Standby Mode”.

According to an advantageous feature of the present invention, one or more power supply modules connected in parallel to a deactivated power supply module may at least proportionately take over the output of the deactivated power supply module. For example, with three power supply modules in a heating circuit, one of which is deactivated, the two active power supply modules can each take over half the output of the deactivated power supply module and can thus be operated in a more favorable operating point.

According to another aspect of the invention, the invention may be implemented in software. The invention may then, on the one hand, also relate to a computer program with program code instructions that can be executed by a computer and, on the other hand, to a storage medium with a computer program, as well as to a process control device or a heating control device with a processing unit, in the memory of which such a computer program is or can be loaded as a means for executing the method and the embodiments thereof. The heating control device can equally perform all tasks mentioned above and below in connection with the process control device.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an exemplary embodiment of the power supply device according to the present invention,

FIG. 2 shows a primary voltage supply and cooling water supply,

FIG. 3 shows another exemplary embodiment of the power supply device according to the present invention,

FIG. 4 shows an example of an optimized power supply for the power supply device of FIG. 1,

FIG. 5 shows an example of a fault in a power supply module in the power supply device of FIG. 1,

FIG. 6 shows an example of a method for operating a power supply device according to the present invention, and

FIG. 7 shows additional details of a power supply module.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

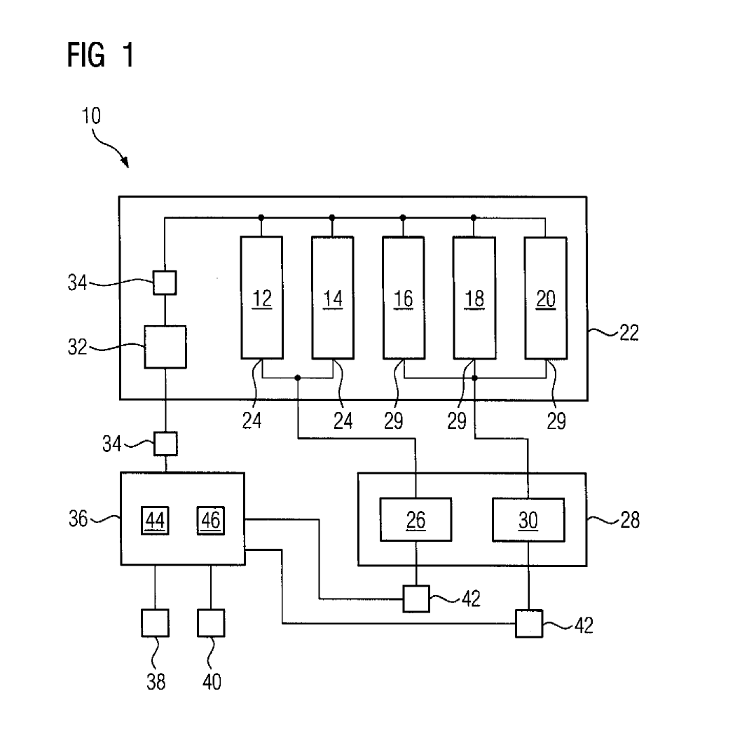

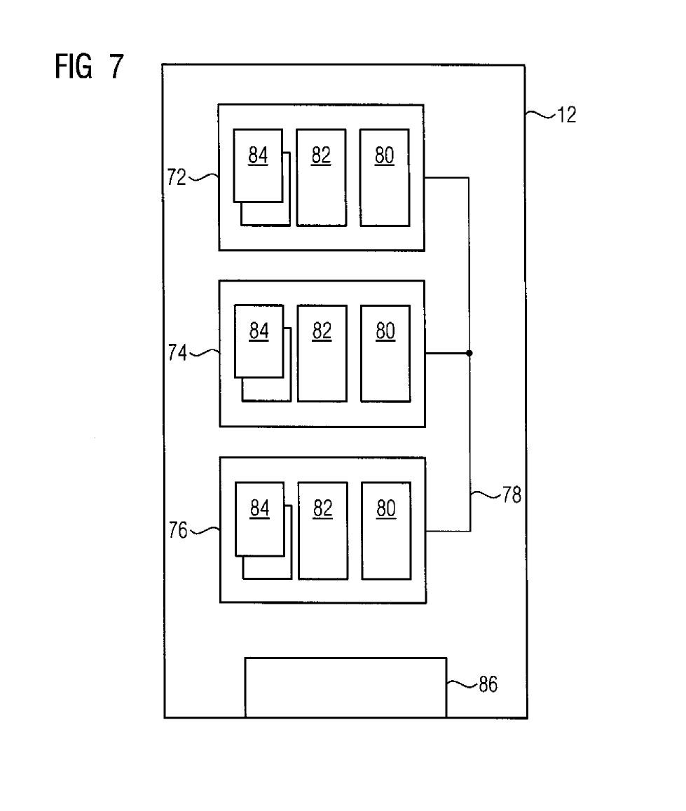

Turning now to the drawing, and in particular to FIG. 1, there is shown an exemplary embodiment of the power supply device 10 according to the present invention. The power supply device 10 includes five power supply modules 12, 14, 16, 18, 20, which are arranged in a switchgear cabinet 22. The outputs 24 of a first and second power supply module 12, 14 are connected in parallel by means of a busbar (not shown) and supply a first heating circuit 26 of a crucible heater 28. The outputs 29 of a third, fourth and fifth power supply module 16, 18, 20 are likewise connected in parallel and supply a second heating circuit 30 of the crucible heater 28. The power supply modules 12-20 each include three identical submodules 72, 74, 76 (FIG. 7), which are connected to one another via an internal system bus 78 (FIG. 7). Each submodule 72-76 generally consists of a rectifier unit 80 (FIG. 7), a power factor correction stage (PFC stage) 82 (FIG. 7), a power converter with transformer and a wide-range output terminal (not shown). Each power supply module 12-20 additionally has a communication interface 86 (FIG. 7) so as to be able to transmit and exchange status and control information, as described below. The control and monitoring of the individual power supply modules 12-20 is effected by a heating control device 32, which communicates with the power supply modules 12-20 via a communication interface 34 and is arranged inside the switchgear cabinet 22. It is however equally possible that the heating control device 32 is arranged outside the switchgear cabinet 22. The heating control device 32 is connected to a communication interface 34 of a process control device 36 which receives status and error messages from individual components such as cooling water monitoring 38, pressure monitoring 40, temperature monitoring 42 for process monitoring and is controlled thereby. The process control device 36 includes a processing unit 44 and a memory 46 for executing or storing a computer program for process monitoring and control. Instead of the process control device 36 the heating control device 32 can also include a processing unit and a memory (both not shown), in order to execute or store a computer program for process monitoring.

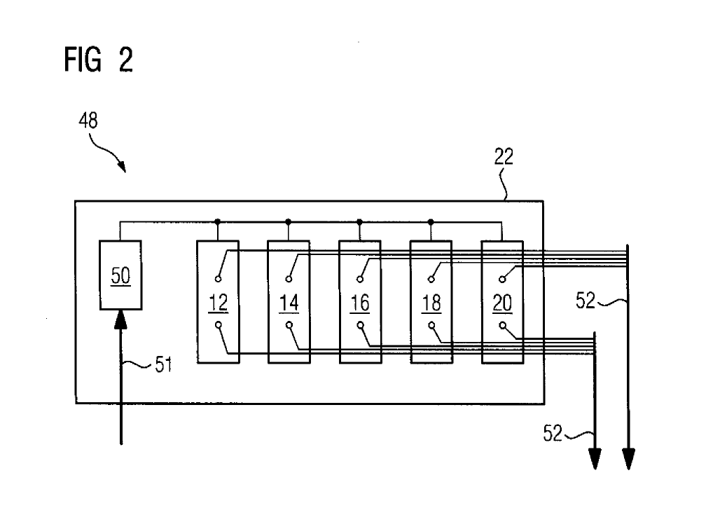

FIG. 2 schematically shows an example of a primary voltage supply 48 for the power supply modules 12-20. The voltage supply 48 includes a switchgear panel 50, with which a supply voltage 51 is routed directly to the power supply modules 12-20. Each power supply module 12-20 is individually connected to a cooling water circuit 52.

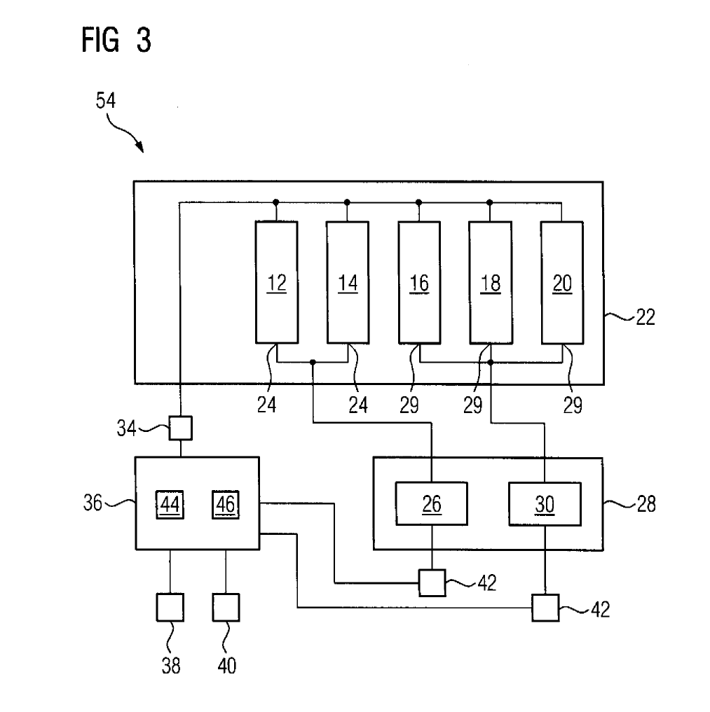

FIG. 3 shows a further exemplary embodiment of an inventive power supply device 54, in which the power supply modules 12-20 are directly connected to the communication interface 34 of the process control device 36 and are directly monitored and controlled by the process control device 36.

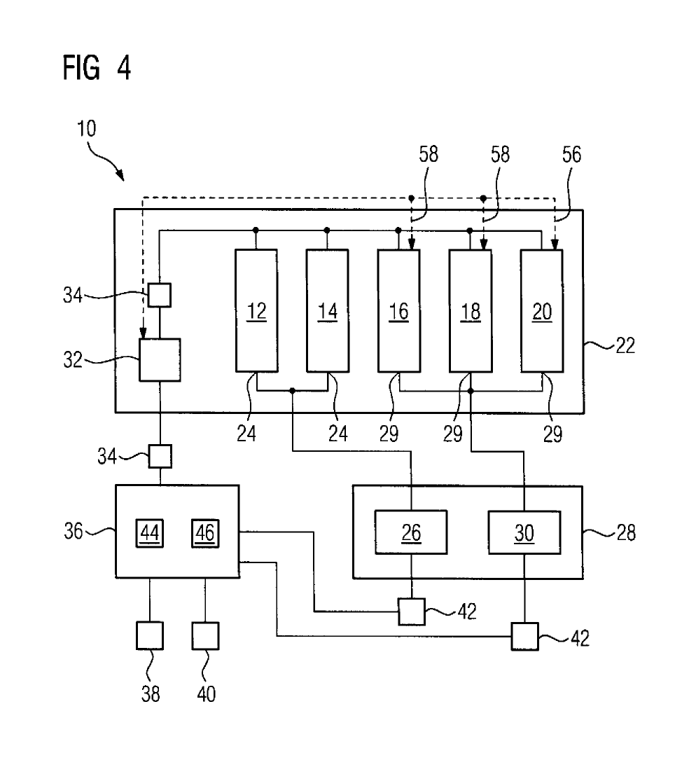

FIG. 4 shows an example of an optimized power supply for the power supply device 10 from FIG. 1. In the partial-load range a power supply module 20 that is no longer required is to this end deactivated. To this end a corresponding control signal 56 is sent from the heating control device 32 to the power supply module 20 to be deactivated. It can be operated in “Hot Standby” or “Cold Standby” as required, i.e. either automatically reactivated or manually brought onto load as required, for example if a fault in one of the power supply modules 16, 18 connected in parallel to the deactivated power supply module 20 is displayed via the communication interface. In each case a corresponding control signal 58 to take over half the output from the deactivated power supply module 20 in each case is sent to the power supply modules 16, 18 still active in the second heating circuit 30. Thus they can be operated in a more favorable operating point. Another output distribution to the power supply modules 16, 18 still active in the second heating circuit 30 can also be determined, so that e.g. one takes over 30 and the other 70 of the output of the deactivated power supply module 20. The values for the output takeovers can be determined such that the still active power supply modules 16, 18 can be operated in as favorable as possible an operating point.

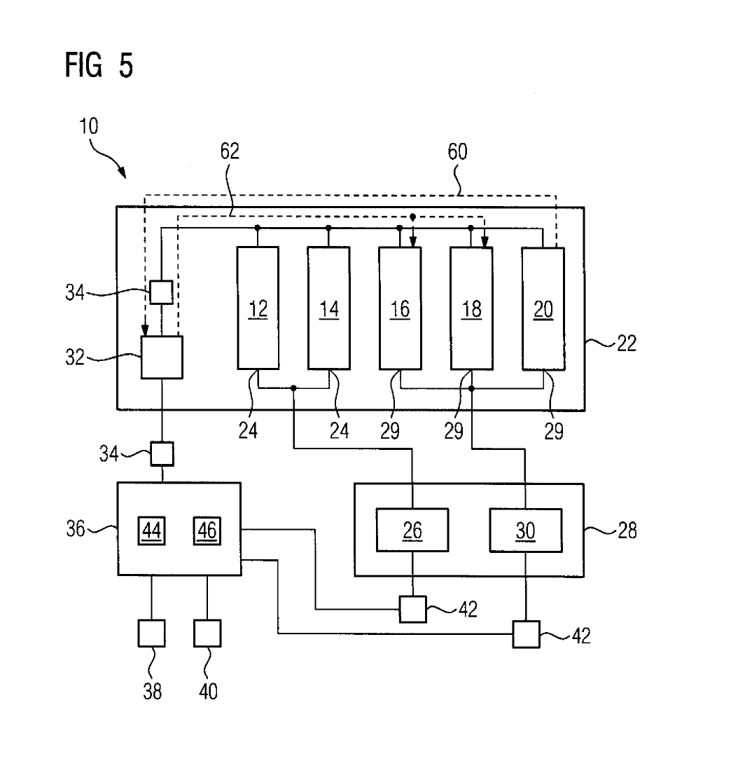

FIG. 5 shows an example of a fault in a power supply module 20 in the power supply device 10. A fault signal 60 is sent to the heating control device 32 from the power supply module 20. The power supply module 20 with the fault is then deactivated by the heating control device 32. At the same time a corresponding control signal 62 is sent from the heating control device 32 to the power supply modules 16, 18 still in the associated second heating circuit 30, so that the output from the defective power supply module 20, e.g. 50 in each case, is additionally assigned to them, providing a heating output required in the second heating circuit 30 is less than or equal to the total of the maximum output of the still available, functioning power supply modules 16, 18.

On termination of the process, e.g. of a crystal growing process, the operational readiness of the power supply device can be restored quickly and with little service effort by replacing the defective power supply module 20. The modular structure of the power supply devices 10, 54 enables the power supply devices 10, 54 to also be adapted for other systems, in particular crystal growing systems, with a modified output requirement for the heating circuits.

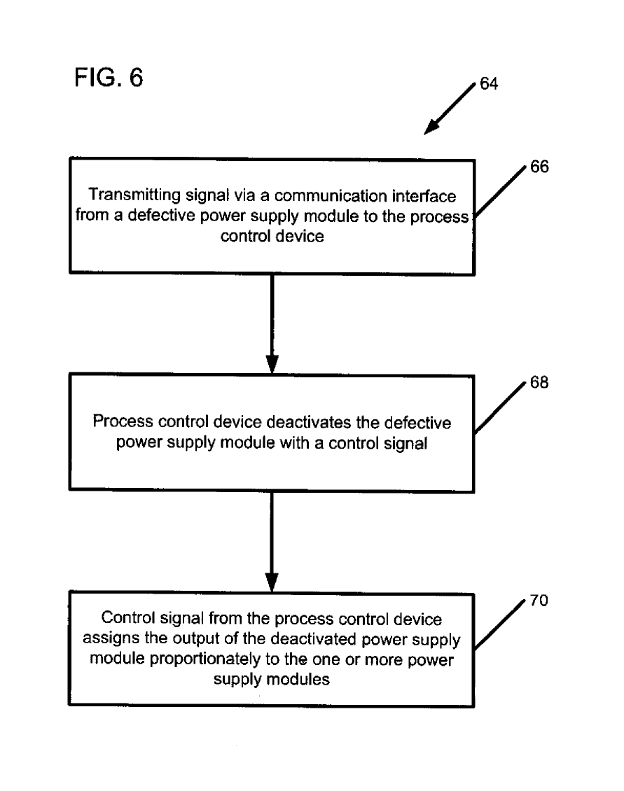

FIG. 6 shows an example of a method 64 for operating an inventive power supply device 10, 54. Here in a first step 66 a signal is transmitted via a communication interface from the defective power supply module to the process control device. In a second step 68 the process control device deactivates the defective power supply module with the aid of a corresponding control signal. In a third step 70 a corresponding control signal from the process control device to the one or more power supply modules active in the associated heating circuit is used to additionally assign the output of the deactivated power supply module proportionately to the one or more power supply modules active in the associated heating circuit if the output required in the associated heating circuit is less than or equal to a maximum output of the active power supply modules.

FIG. 7 shows with reference to an exemplary power supply module 12, 14, 16, 18, 20, here the first power supply module 12, in particular embodiment illustrating that this power supply module 12 includes three identical submodules 72, 74, 76, which are connected with each other via an internal system bus 78. Each of these submodules 72-76 includes a rectifier unit 80. Each the module 72-76 further includes a power factor correction stage 82. Clocked power stages 84 are connected to downstream of the power factor correction stage 82. In addition, each power supply module 12-20 includes a communication interface 86.

Individual highlighted aspects of the description filed here can be briefly summarized as follows: a power supply device 10, 54 for a crucible heater 28 is specified, including at least one heating circuit 26, 30, which in each case includes at least two power supply modules 12, 14, 16, 18, 20, output terminals 24, 29 of the at least two power supply modules 12-20 being connected in parallel in the or each heating circuit 26, 30, and a process control device 36 being specified for controlling the power supply modules 12-20.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A power supply device for a crucible heater, comprising:
at least one heating circuit having an input terminal,
at least two power supply modules having each an output terminal, with the output terminals of at least two power supply modules being connected in parallel to the input terminal of the at least one heating circuit and
a process control device for controlling the at least two power supply modules.

2. The power supply device of claim 1, further comprising a heating control device connected between the process control device and the at least two power supply modules, said heating control device configured for controlling and monitoring the at least two power supply modules.

3. The power supply device of claim 1, wherein an input side of each of the at least two power supply modules is connected to a three-phase power supply.

4. The power supply device of claim 1, wherein each of the at least two power supply modules comprises three identical submodules which are connected to one another via an internal system bus.

5. The power supply device of claim 4, wherein each submodule comprises a rectifier unit.

6. The power supply device of claim 4, wherein each submodule comprises a power factor correction stage.

7. The power supply device of claim 6, further comprising clocked output stages connected downstream of the power factor correction stage.

8. The power supply device of claim 1, wherein each of the at least two power supply modules comprises a communication interface.

9. A method for operating a power supply device for a crucible heater having at least one heating circuit with at least two power supply modules and a process control device for controlling the at least two power supply modules, the method comprising the steps of:
connecting output terminals of the at least two power supply modules in parallel and connecting the parallel connection to a corresponding heating circuit, and
activating or deactivating the at least two power supply modules separately for each heating circuit as a function of a process flow or when a malfunction occurs in individual power supply modules.

10. The method of claim 9, and further comprising the step of
transmitting, when a malfunction occurs in individual power supply modules, a signal via a communication interface from the malfunctioning power supply module to a heating control device connected between the process control device, and
deactivating the malfunctioning power supply module with the heating control device.

11. The method of claim 9, and further comprising the step of
transmitting, when a malfunction occurs in individual power supply modules, a signal via a communication interface from the malfunctioning power supply module to the process control device, and
deactivating the malfunctioning power supply module with the process control device.

12. The method of claim 9, and further comprising the step of
additionally proportionally assigning output power previously produced by the deactivated malfunctioning power supply module to the one or more power supply modules that remain active in the associated heating circuit, when output power required in the associated heating circuit is less than or equal to a maximum output power of the power supply modules that remain active.

13. The method of claim 9, and further comprising the step of
deactivating a power supply module that is no longer required, and
automatically activating the no-longer-required power supply module when a failure or a malfunction occurs in a power supply module having parallel-connected output terminals.

14. The method of claim 13, wherein the power supply modules connected in parallel to a deactivated power supply module supply at least proportionately the output power previously supplied by the deactivated power supply module.

15. A computer program product having program code which is stored on a non-transitory computer-readable data carrier, wherein the program code, when loaded into a memory of a process control device or heating control device and executed on the process control device or heating control device, causes the process control device or heating control device to operate a power supply device for a crucible heater having at least one heating circuit by:
connecting output terminals of at least two power supply modules in parallel and connecting the parallel connection to a corresponding heating circuit, and
activating or deactivating the at least two power supply modules separately for each heating circuit as a function of a process flow or when a malfunction occurs in individual power supply modules.

16. A digital non-transitory computer-readable storage medium having control signals which when loaded into a memory of a programmable process control device or heating control causes the process control device or heating control device to operate a power supply device for a crucible heater having at least one heating circuit by:
connecting output terminals of at least two power supply modules in parallel and connecting the parallel connection to a corresponding heating circuit, and
activating or deactivating the at least two power supply modules separately for each heating circuit as a function of a process flow or when a malfunction occurs in individual power supply modules.

17. A process control device or a heating control device comprising:
a memory, and
a processing unit configured to execute, during operation of the process control device or a heating control device, program code which when loaded into the memory of the processing unit and executed on the processing unit causes the process control device or heating control device to operate a power supply device for a crucible heater having at least one heating circuit by:
connecting output terminals of at least two power supply modules in parallel and connecting the parallel connection to a corresponding heating circuit, and
activating or deactivating the at least two power supply modules separately for each heating circuit as a function of a process flow or when a malfunction occurs in individual power supply modules.
